(19) United States
(12) Patent Application Publication
(10) Pub. No.: US 2008/0265794 A1
(43) Pub. Date: Oct. 30, 2008

(54) CURRENT-DRIVEN TOROIDAL-MAGNETIC-CORE-FREE FEEDBACK TYPE BALLAST

(76) Inventor: Onn Fah FOO, Tsimshatsui (HK)

Correspondence Address: RABIN & BERDO, P.C., Suite 500, 1101 14 Street, N.W., Washington, DC, 20005, US

(21) Appl. No.: 11/924,913

(22) Filed: Oct. 26, 2007

(30) Foreign Application Priority Data
Oct. 27, 2006 (CN) 200610159823.4

(51) Int. Cl. H05B 41/24

(52) U.S. Cl. 315/276

(57) ABSTRACT

A current driven toroid-free feedback type ballast comprising a filter and rectifier circuit, a switch and resonant circuit and a lamp load including capacitors, wherein the filter and rectifier circuit is coupled to input ends of the switch and resonant circuit with its output ends; the switch and resonant circuit is coupled to the lamp load with its output ends and comprising: a trigger circuit comprised of resistors R1, R2, a capacitor C3, a diode D5 and a trigger diode DB3; a half bridge circuit comprised of transistors Q1, Q2 and resistors; and a three winding transformer T comprised of primary winding T3 and two secondary windings T1, T2. In the current driven toroid-free feedback type ballast of the present invention, the switch and resonant circuit employs a half bridge circuit of transistors together with the transformer to effect driving feedback such that the ballast possess the advantage of toroid-free, which leads to enhanced liability of the lamp load, simplified circuit configuration and manufacturing process whereby to facilitate the miniaturization of electronic ballasts.

### TECHNICAL FIELD

The present invention relates to a ballast, and more particularly to a current driven toroid-free feedback type ballast.

### BACKGROUND OF THE INVENTION

Most of the commonly available integrated electronic ballasts in the market are consisting of an EMI filter, a rectifier, an inverter and a lamp load. The inverter converts rectified direct current voltage to high frequency voltage and being used to drive and ignite a fluorescent lamp, wherein there exist various kinds of inverters among which a half-bridge inverter, flyback inverter, push-pull inverter or the like will be usually realized with a toroid transformer. However, the use of toroid transformer possess following disadvantages.

The turnon and turnoff of transistors in the circuit is driven by the toroid transformer, when the external power source fluctuates (rise and fall), variations in drive voltage, underexcitation or overexcitation will be occurred such that the transistor is severely heated or even broken down as the result of being overheated whereby the liability of the lamp load is reduced.

The processing and winding of the toroid are labour intensive and time consuming and being adverse to mass production thereof. The working frequency of the circuit is greatly affected by the parameters and temperature of the toroid thereby it is hard to be kept within a specific range. If there exits further requirements on the range of working frequency, it is hard to implement them in mass production.

In order to minimize the effects of a toroid to an electronic ballast, the Chinese Utility Model Patent No. 99211363.6 to Chinese Academic of Sciences disclosed “An energy saving lamp having a toroid-free ballast”, wherein the half bridge power amplifier of the energy saving lamp is realized with FETs but the manufacturing process for FET is relatively complex and the selectivity thereof is relatively poor. Further, the driving current limiter of the energy saving lamp is realized with a load transformer, and thus, the driving current limiter has to be connected with inductors L1, L2 and capacitors C1, C2 (see FIG. 1), which results in a complicated circuitry and increased cost and brings adverse effect to the miniaturization of the electronic ballast.

### SUMMARY OF THE INVENTION

An object of the present invention is to overcome the above defects by providing a current driven toroid-free feedback type electronic ballast having its switch and rectifier circuit adopted a transistor half bridge circuit and a induction transformer to realize drive feedback and facilitate the miniaturization of the electronic ballast.

Accordingly, the technical solution of the present invention provided for the above object being a current driven toroid-free feedback type electronic ballast, which comprises a filter and rectifier circuit, a switch and resonant circuit and a lamp load including capacitors, wherein

the filter and rectifier circuit is coupled to input ends of the switch and resonant circuit with its output ends; and
the switch and resonant circuit is coupled to the lamp load with its output ends and includes: a trigger circuit comprised of resistors R1, R2, a capacitor C3, a diode D5 and a trigger diode DB3 to provide a pulse current for initiation of its operation; a half bridge circuit comprised of transistors Q1, Q2 and resistors; and a three winding transformer T comprised of a primary winding T3 and two secondary windings T1, T2; wherein emitter of transistor Q1 is coupled with collector of Q2 via a resistor R5; a junction S is located between the resistor R5 and the collector of the transistor Q2; the resistor R1 and a capacitor C2 in shunt connection are located between collector of the transistor Q1 and the junction S; the resistor R1 is coupled to terminal 3 of the filter and rectifier circuit with its one end and coupled to terminal 1 of the filter and rectifier circuit with its another end through the resistor R2 and the shunted diode D5 in series connection with the capacitor C3; the diode D5 is coupled to base of the transistor Q2 with its anode via the bilateral diode DB3 and coupled to terminal 4 of the secondary winding T1 and terminal 1 of the primary winding T3 with its cathode through the junction S; base of the transistor Q1 is coupled to terminal 3 of the secondary winding T1 through a resistor R3, and the base of the transistor Q2 is coupled to terminal 6 of the secondary winding T2 through a resistor R4; emitter of the transistor Q2 is coupled to terminal 5 of the secondary winding T2 through a resistor R6, while the terminal 5 of the secondary winding T2 is coupled with terminal 1 of the filter and rectifier circuit for enabling the secondary windings T1, T2 to provide a drive current for the transistors Q1, Q2; terminal 2 of the primary winding T3 is coupled to the lamp load and a capacitor C5 for enabling the primary winding T3 and the capacitor C5 to form a series resonance.

In the above current driven toroid-free feedback type ballast, the switch and resonant circuit further comprises a resonant capacitor C6 having its one end coupled with the terminal 2 of the secondary winding T1 and its another end coupled with the terminal 5 of the secondary winding T2.

In the above current driven toroid-free feedback type ballast, the filter and rectifier circuit is a full bridge rectifier circuit comprising a bridge rectifier, a filter of an inductor and a resistor in shunt connection and an electrolyte capacitor C1 connected across terminals 1 and 3 of the bridge rectifier; the filter is coupled with AC power supply at one end via a fuse while coupling with terminal 4 of the bridge rectifier at another end.

In the above current driven toroid-free feedback type ballast, the filter and rectifier circuit comprises a voltage multiplying rectifier circuit as its rectifier circuit.

In the above current driven toroid-free feedback type ballast, it further comprises a power factor correction circuit having its input end coupled with the output end of the filter and rectifier circuit and its output end coupled with the input end of the switch and resonant circuit.

In the above current driven toroid-free feedback type ballast, the power factor correction circuit comprises a MOSFET VT1, a booster inductor L, a booster diode VD, an output capacitor C0 and an APFC controller integrated circuit; wherein the booster inductor L is coupled to terminal 3 of bridge rectifier with one end and coupled to the collector of the transistor Q1 with another end through the booster diode VD; the booster diode VD is coupled with terminal 1 of the bridge rectifier at its cathode via the output capacitor C0 and coupled with the terminal 1 of the bridge rectifier at its anode via the MOSFET VT1, while gate of the MOSFET VT1 is coupled to the APFC.

In the above current driven toroid-free feedback type ballast, the lamp load comprises a lamp tube and capacitors C4, C5; wherein at both ends of the lamp tube two connection points a, b, a′, b′ are respectively provided, the capacitor C5 in shunt connection with the lamp tube is connected across one connection point b, b′ at both ends of the lamp tube; another connection point a′ at one end of the lamp tube is coupled with the terminal 2 of the three winding transformer, while another connection point a at another end of the lamp tube is coupled with the collector of the transistor Q1 via the capacitor C4.

In the above current driven toroid-free feedback type ballast, the capacitor C5 in shunt connection with the lamp tube is further in shunt connection with a PTC preheating device.

In the above current driven toroid-free feedback type ballast, the ratio of winding between the primary winding and the secondary winding of the three winding transformer ranges from 30:1 to 400:1.

In the above current driven toroid-free feedback type ballast, the resistors R5 and R6 are equal in resistance.

The present invention provides a current driven toroid-free feedback type ballast, which comprises a filter and rectifier circuit, a switch and resonant circuit and a lamp load; wherein a filter circuit is used to eliminate the electromagnetic interference occurred from conduction, a rectifier circuit converts the ac voltage to dc ripple voltage; the secondary windings feedback of the transformer provide driving currents for the transistors to effect switch oscillation of the switch and resonant circuit, the primary winding T of the transformer and filament capacitance form a LC oscillation circuit to ignite the lamp tube. As the transistor half bridge circuit of the switch and resonant circuit of the ballast employs three winding transformer feedback instead of a toroid feedback for driving the transistors to effect oscillation, the ballast possess the advantage of toroid-free while the circuit configuration and manufacturing process are simplified and the liability of the lamp load is enhanced.

### BRIEF DESCRIPTION OF THE DRAWINGS

FIG. 1 is a circuit diagram of a ballast of the prior art;

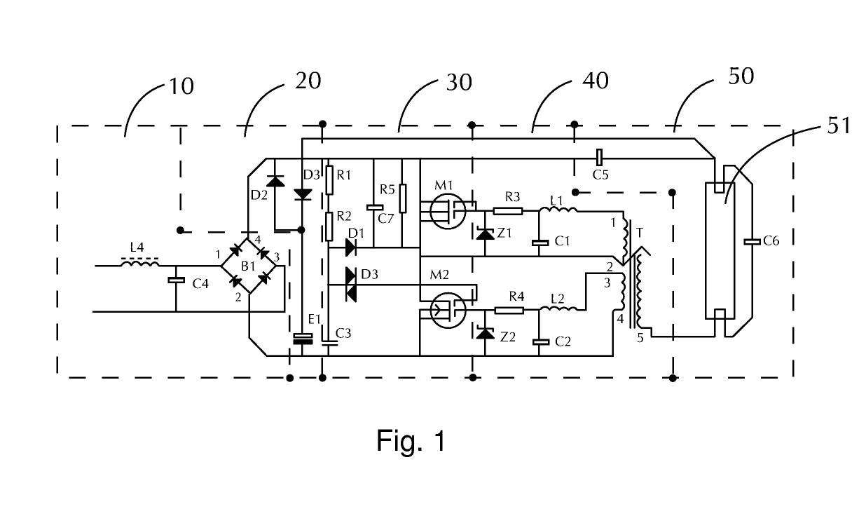

FIG. 2 is a circuit configuration diagram of a current driven toroid-free feedback type ballast according to 1^{st} embodiment of the present invention;

FIG. 3 is a circuit configuration diagram of a current driven toroid-free feedback type ballast according to 2^{nd} embodiment of the present invention;

FIG. 4 is a circuit configuration diagram of a current driven toroid-free feedback type ballast according to 3^{rd} embodiment of the present invention;

FIG. 5 is a circuit configuration diagram of a current driven toroid-free feedback type ballast according to 4^{th} embodiment of the present invention;

FIG. 6 is a circuit configuration diagram of a current driven toroid-free feedback type ballast according to 5^{th} embodiment of the present invention;

FIG. 7 is a circuit configuration diagram of a current driven toroid-free feedback type ballast according to 6^{th} embodiment of the present invention;

FIG. 8 is a circuit configuration diagram of a current driven toroid-free feedback type ballast according to 7^{th} embodiment of the present invention;

FIG. 9 is a circuit configuration diagram of a current driven toroid-free feedback type ballast according to 8^{th} embodiment of the present invention.

### DETAILED DESCRIPTION OF THE PREFERRED EMBODIMENTS

The current driven toroid-free feedback type ballast of the present invention will be described in further details below with reference to the accompany drawings.

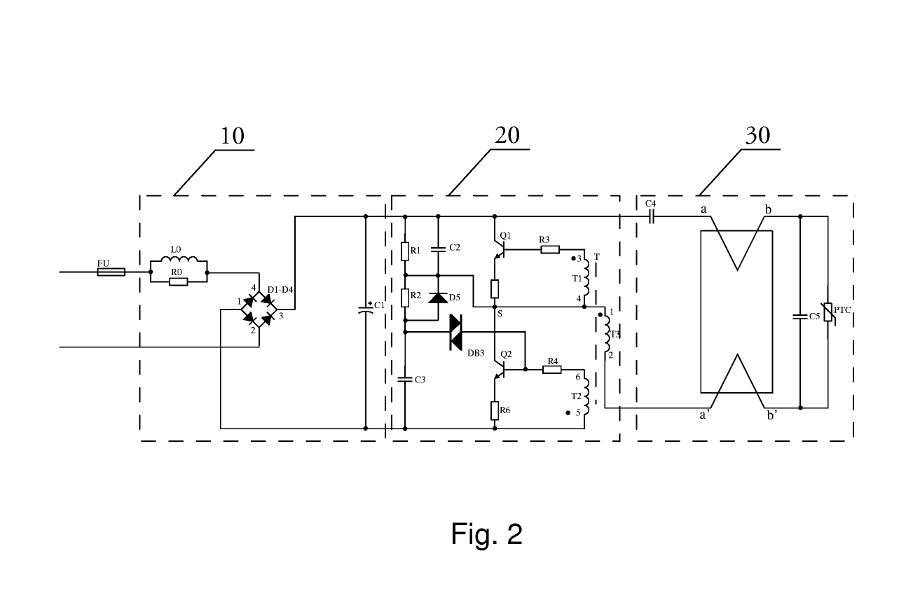

Please refer to FIG. 2, which illustrates a current driven toroid-free feedback type ballast according to 1^{st} embodiment of the present invention comprising a filter and rectifier circuit 10, a switch and resonant circuit 20 and a lamp load 30 having capacitors, and the same is now described hereunder.

The filter and rectifier circuit 10 is coupled to input ends of the switch and resonant circuit 20 with its output ends, and being further coupled to an AC power supply to convert input ac voltage to dc ripple voltage after filtering out the electromagnetic interference thereof. In the embodiment, the filter and rectifier circuit 10 is a full bridge rectifier circuit comprising a bridge rectifier (D1-D4), a filter comprised of an inductor L0 and a resistor R0 in shunt connection and an electrolyte capacitor C1 connected across terminals 1 and 3 of the bridge rectifier; the filter is coupled with the AC power supply at one end via a fuse FU resistor while coupling with terminal 4 of the bridge rectifier at another end.

The switch and resonant circuit 20 is coupled to the lamp load 30 with its output ends and including: a trigger circuit comprised of resistors R1, R2, a capacitor C3, a diode D5 and a trigger diode DB3 to provide a pulse current for initiation of the operation of the switch and resonant circuit 20; a half bridge circuit comprised of transistors Q1, Q2 and resistors for acting as a power switch; and a three winding transformer T comprised of a primary winding T3 and two secondary windings T1, T2, wherein the primary winding T3 also possesses a choking effect. Preferably, the ratio of winding between the primary winding and the secondary winding of the three winding transformer might range from 30:1 to 400:1. In the switch and resonant circuit 20, the emitter of transistor Q1 is coupled with collector of Q2 via a resistor R5; a junction S is located between the resistor R5 and the collector of the transistor Q2; the resistor R1 and a capacitor C2 in shunt connection are provided between collector of the transistor Q1 and the junction S; the resistor R1 is coupled to terminal 3 of the rectifier of the filter and rectifier circuit 10 with its one end and coupled to terminal 1 of the rectifier of the filter and rectifier circuit 10 with its another end through the resistor R2 and the shunted diode D5 in series connection with the capacitor C3; the diode D5 is coupled to base of the transistor Q2 with its anode via the bilateral diode DB3 and coupled to terminal 4 of the secondary winding T1 and terminal 1 of the primary winding T3 with its cathode through the junction S; the base of the transistor Q1 is coupled to terminal 3 of the secondary winding T1 through a resistor R3, and the base of the transistor Q2 is coupled to terminal 6 of the secondary winding T2 through a resistor R4; emitter of the transistor Q2 is coupled to terminal 5 of the secondary winding T2 through a resistor R6, while the terminal 5 of the secondary winding T2 is coupled with terminal 1 of the rectifier of the filter and rectifier circuit 10 for enabling the secondary windings T1, T2 to provide a drive current for the transistors Q1, Q2; terminal 2 of the primary winding T3 is coupled to the lamp load 30 and a capacitor C5 for enabling the primary winding T3 and the capacitor C5 to form a series resonance.

The lamp load 30 comprises a lamp tube and capacitors C4, C5 wherein the capacitor C4 is used for dc blocking; and at both ends of the lamp tube two connection points a, b, a′, b′ are respectively provided, the capacitor C5 in shunt connection with the lamp tube is connected across one connection point b, b′ at both ends of the lamp tube; another connection point a′ at one end of the lamp tube is coupled with the terminal 2 of the primary winding T3, while another connection point a at another end of the lamp tube is coupled with the collector of the transistor Q1 via the capacitor C4. According to one preferred embodiment, the capacitor C5 is further in shunt connection with a PTC preheating device.

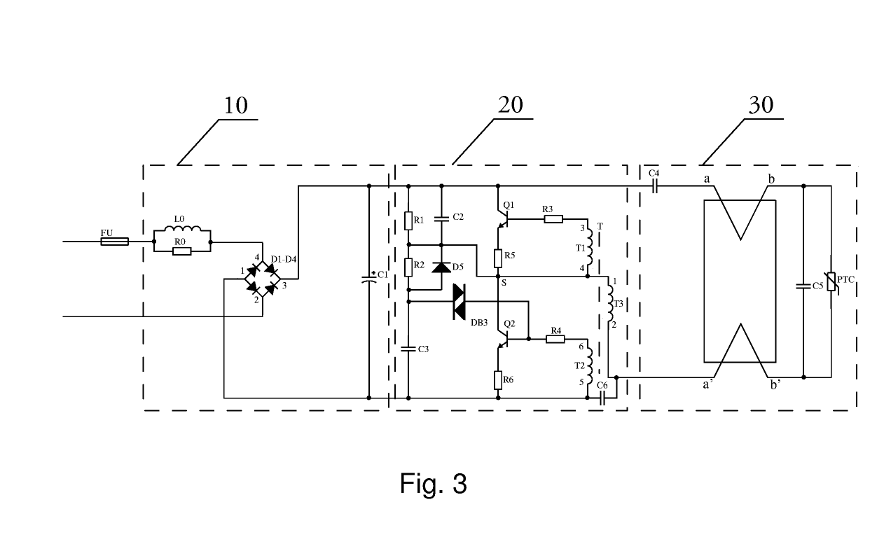

Please refer to FIG. 3, a current driven toroid-free feedback type ballast according to 2^{rd} embodiment of the present invention is illustrated, which comprises the entire circuit of the first embodiment but the switch and resonant circuit further comprises a resonant capacitor C6 having its one end coupled with the terminal 2 of the secondary winding T3 and its another end coupled with the terminal 5 of the secondary winding T2.

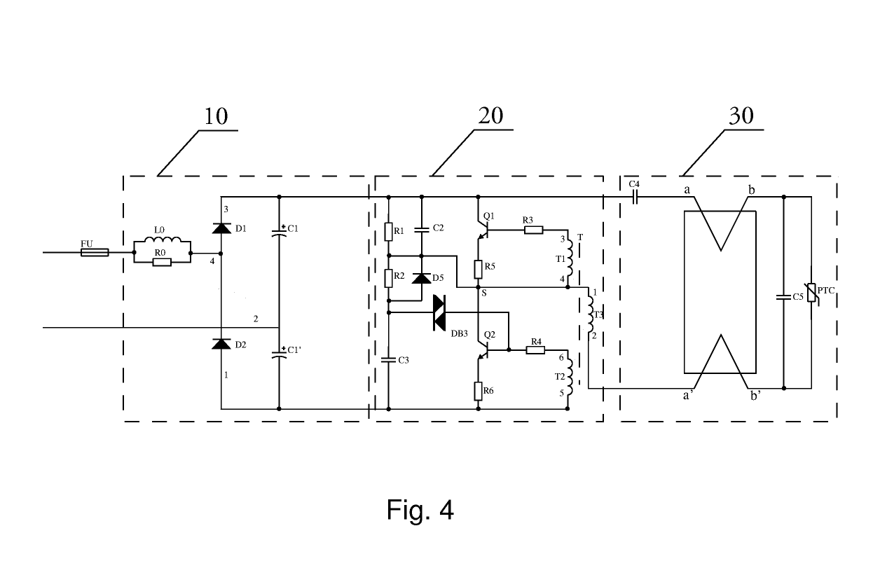

Please refer to FIG. 4, a current driven toroid-free feedback type ballast according to 3^{rd} embodiment of the present invention is illustrated, wherein the switch and resonant circuit 20 and the lamp load 30 are the same as the first embodiment. However, the rectifier circuit in the filter and rectifier circuit 10 of the present embodiment is a voltage multiplying rectifier circuit formed with two diodes and two capacitors.

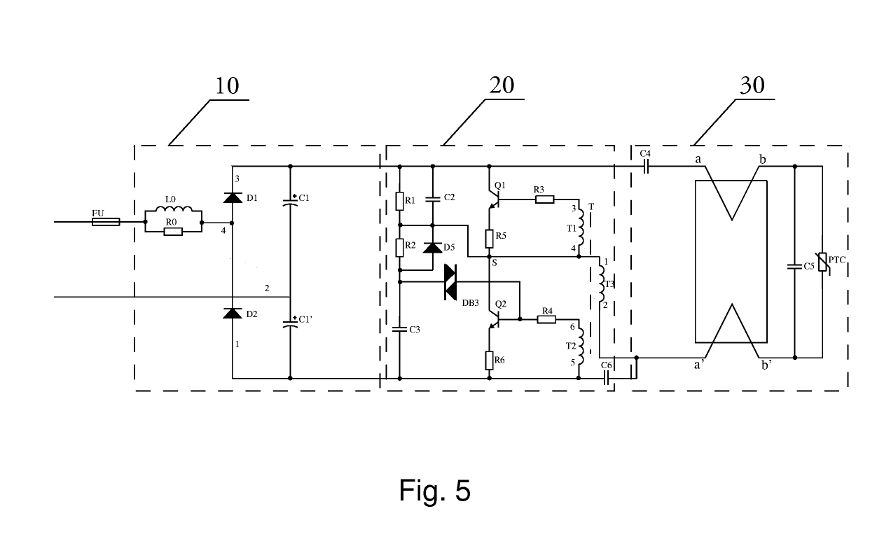

Please refer to FIG. 5, a current driven toroid-free feedback type ballast according to 4^{th} embodiment of the present invention is illustrated, which comprises the entire circuit of the third embodiment but the switch and resonant circuit 20 further comprises a resonant capacitor C6 which is coupled therewith in the same manner as in the second embodiment.

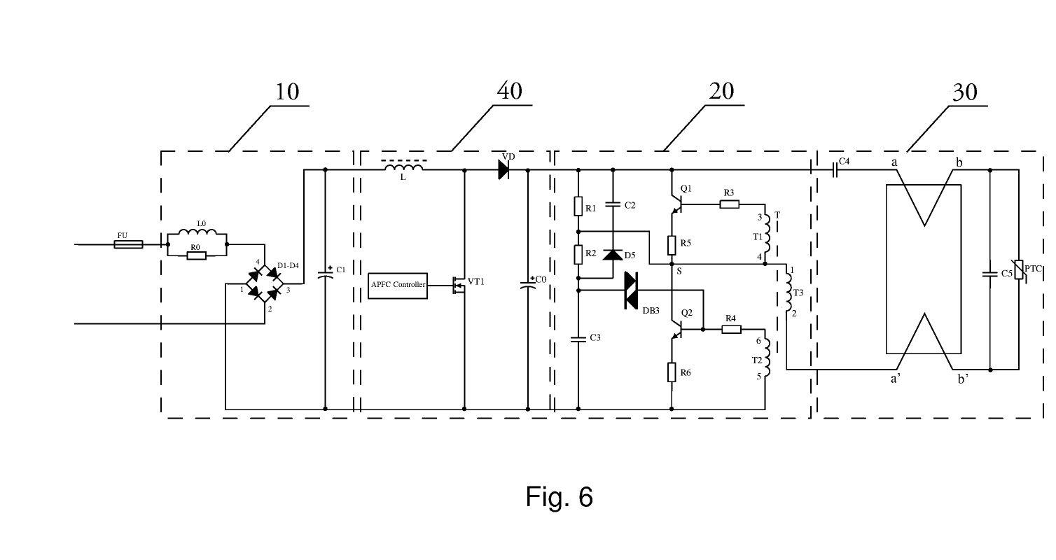

Please refer to FIG. 6, a current driven toroid-free feedback type ballast according to 5^{th} embodiment of the present invention is illustrated, which comprises the entire circuit of the first embodiment and further comprises a power factor correction circuit 40. It should be noted that the necessity of the arrangement of the optional power factor correction circuit 40 depends on the power to be attained by the current driven toroid-free feedback type ballast. The circuit 40 is coupled to the output end of the filter and rectifier circuit 10 with its input end and coupled to the input end of the switch and resonant circuit 20 with its output end. The power factor correction circuit 40 comprises a MOSFET VT1, a booster inductor L, a booster diode VD, an output capacitor C0 and an APFC controller integrated circuit; wherein the booster inductor L is coupled to terminal 3 of bridge rectifier with one end and coupled to the collector of the transistor Q1 with another end through the booster diode VD; the booster diode VD is coupled with terminal 1 of the bridge rectifier at its cathode via the output capacitor C0 and coupled with the terminal 1 of the bridge rectifier via the MOSFET VT1, while the gate of the MOSFET VT1 is coupled to the APFC.

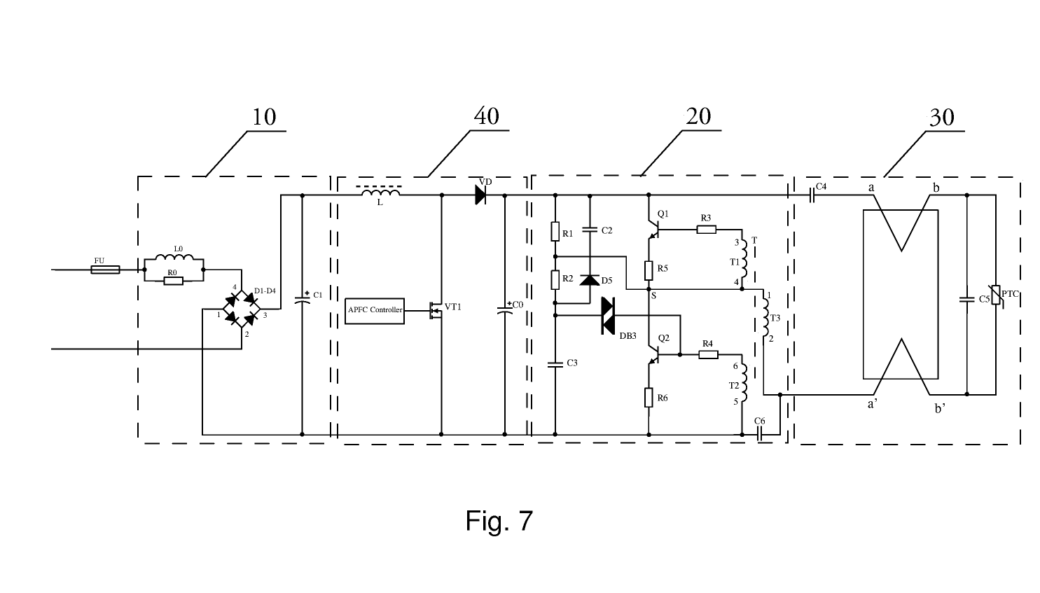

Please refer to FIG. 7, a current driven toroid-free feedback type ballast according to 6^{th} embodiment of the present invention is illustrated, which comprises the entire circuit of the fifth embodiment but the switch and resonant circuit 20 further comprises a resonant capacitor C6 being coupled therewith in the same manner as in the second embodiment.

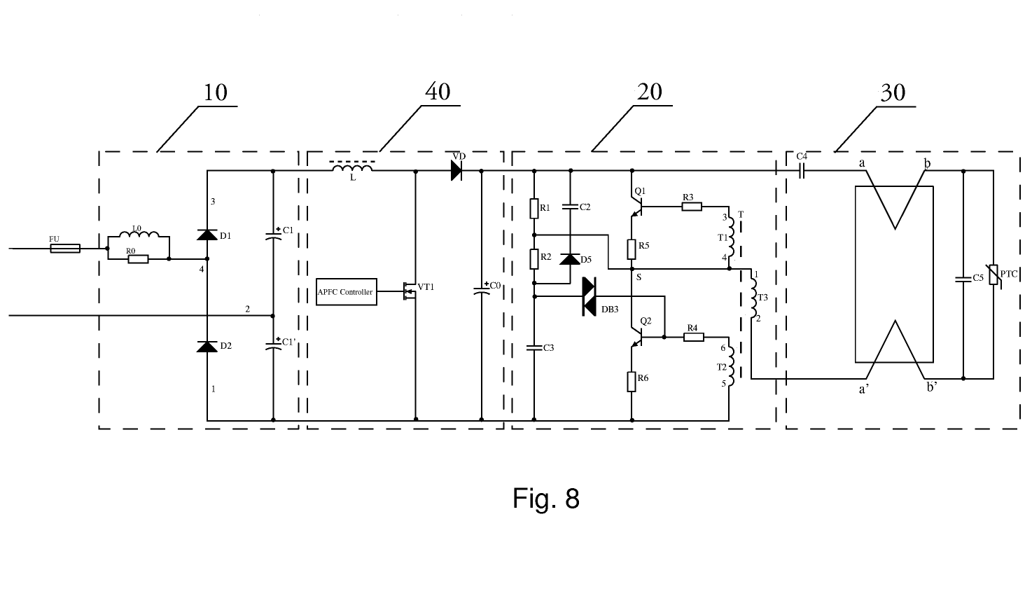

Please refer to FIG. 8, a current driven toroid-free feedback type ballast according to 7^{th} embodiment of the present invention is illustrated, which comprises the entire circuit of the third embodiment but it further comprises a power factor correction circuit 40 being coupled therewith in the same manner as in the fifth embodiment.

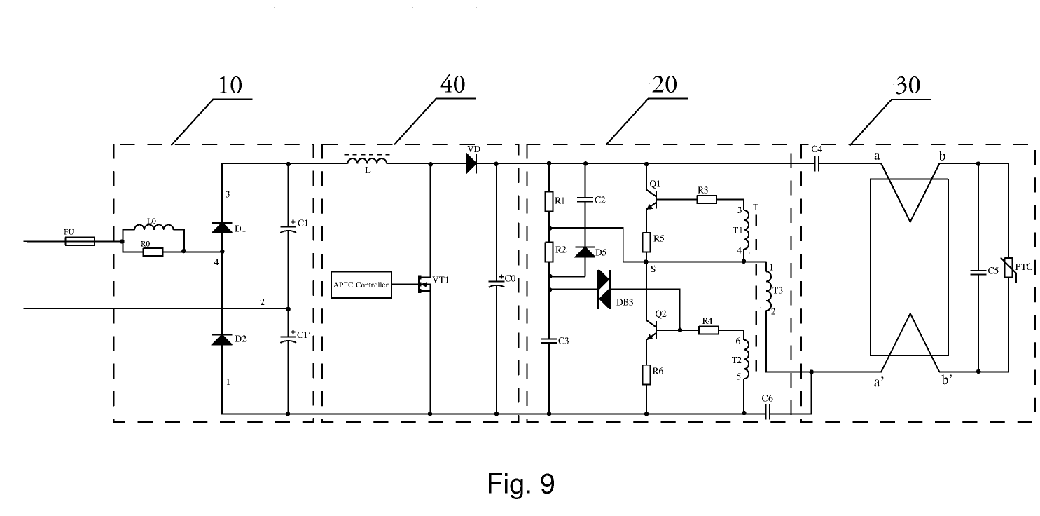

Please refer to FIG. 9, a current driven toroid-free feedback type ballast according to 8^{th} embodiment of the present invention is illustrated, which comprises the entire circuit of the seventh embodiment but the switch and resonant circuit 20 further comprises a resonant capacitor C6 being coupled therewith in the same manner as in the second embodiment.

The working principle of the present invention is as follows. After connecting with the power supply, the current from the dc voltage charge up the integrating capacitor C3 after passing through the resistors R1, R2 of the trigger circuit, once the voltage thereof reaches or exceeds the breakdown voltage of the trigger diode DB3 (about 30-40V), the trigger diode will conduct in reverse such that a current flows into the base of the transistor Q2 and turns on Q2. As the collector current of the transistor Q2 is increasing, induced electrodynamic potentials are generated on the primary winding T3 and also the secondary windings T1, T2 of the transformer, (wherein the ends denoted with • represent a positive polarity) such that the base potential of Q2 rises whereby the base current and collector current thereof is further increased which in turns boost further the base potential. In this regard, chain reaction takes place in the circuit and such chained positive feedback makes Q2 conducting and saturating. The resistor R6 at emitter of Q2 is provided for effecting negative current feedback, and in the process of the chain reaction, the increase of base current also makes the voltage drop on R6 increasing and the increased portion of the voltage drop will be looped back to the base-emitter loop of the Q2 whereby the voltage applied from the outside of the base-emitter of the Q2 is decreased and the base current will be also automatically reduced, which in turns restrain the increase of the collector current. By increasing the resistance of the resistor R6 at the emitter, the negative feedback action thereof will be enhanced such that the working frequency can be increased.

After the transistor Q2 is turned on, along with the increase of the collector current passing through the transistor Q2, there are circumstances that the voltage on the secondary winding T2 of the transformer will possibly drop below the base voltage of the transistor Q2 such that the base current is reversed whereby the transistor Q2 quits from its saturated mode and enters into amplifying mode. Once it enters into the amplifying mode, the decrease in the current flowing through the collector of the transistor Q2 will reduce the base current with the positive feedback of the transformer such that the collector current is further decreased and Q2 will be soon entering cutoff mode while the polarity of the voltage on the secondary winding T1 of the transformer is changed (now terminal 3 is positive and terminal 4 is negative). After delaying for a period of time, a current occurs in the transistor Q1, the transformer will generate an induced electrodynamic potential being opposite to the same generated from the increase of the collector current of Q2 such that the base and collector current of Q1 is further increased and Q1 will quickly be changed from cutoff state to turnon state. The resistor R5 at emitter of Q1 is also provided for effecting negative current feedback and the working principle thereof is the same as R6, the resistors R5, R6 are equal in their resistance.

The above process moves in cycles, wherein Q1 and Q2 are alternatively turned on and off. In the middle point between two half bridge an alternating square wave voltage is formed. After passing through the capacitor C5 and being affected by the action of the series resonant of the primary winding T3 of the transformer, the waveform of such alternating voltage will be changed to resemble a sine wave, and a very high voltage is generated on C5 and then applied to the lamp tube for the ignition of the same.

It should be appreciated that the above are only provided for illustrating but not limiting the technical solutions of the present invention. While the present invention has been described in details with references to above embodiments, it will be understood by those skilled in the art that various changes, additions or deletions may be made and equivalents may be substituted for elements thereof without departing from the spirit and scope of the invention and its claims, and all such alteration and/or modification shall fall into the scope of the present invention.

What is claimed is:

1. A current driven magnetic toroid-free feedback type ballast comprising a filter and rectifier circuit, a switch and resonant circuit and a lamp load including capacitors, wherein
Output ends of the filter and rectifier circuit are coupled to input ends of the switch and resonant circuit, while
Outputs ends of the switch and resonant circuit are coupled to the lamp load, wherein the switch and resonant circuit includes a trigger circuit comprised of resistors R1, R2, a capacitor C3, a diode D5 and a trigger diode DB3 to provide a pulse current for initiation of its operation; a half bridge circuit comprised of transistors Q1, Q2 and resistors; and a three winding transformer T comprised of primary winding T3 and two secondary windings T1, T2; wherein emitter of transistor Q1 is coupled with collector of Q2 via a resistor R5; a junction S is located between the resistor R5 and the collector of the transistor Q2; the resistor R1 and a capacitor C2 are connected in a shunt manner between collector of the transistor Q1 and the junction S; one end of the resistor R1 is coupled to terminal 3 of the filter and rectifier circuit and the other end thereof to terminal 1 of the filter and rectifier circuit through the shunted resistor R2 and diode D5 and series capacitor C3; the anode of diode D5 is coupled to base of the transistor Q2 via the bilateral diode DB3 and cathode thereof to terminal 4 of the secondary winding T1 and terminal 1 of the primary winding T3 through the junction S; the base of the transistor Q1 is coupled to terminal 3 of the secondary winding T1 through a resistor R3, and the base of the transistor Q2 is coupled to terminal 6 of the secondary winding T2 through a resistor R4; emitter of the transistor Q2 is coupled to terminal 5 of the secondary winding T2 through a resistor R6, while the terminal 5 of the secondary winding T2 is coupled with terminal 1 of the filter and rectifier circuit for enabling the secondary windings T1, T2 to provide a drive current for the transistors Q1, Q2; terminal 2 of the primary winding T3 is coupled to the lamp load and a capacitor C5 for enabling the primary winding T3 and the capacitor C5 to create a series resonance.

2. A current driven toroid-free feedback type ballast according to claim 1, wherein the switch and resonant circuit further comprises a resonant capacitor C6, one end of which is coupled with the terminal 2 of the secondary winding T1 and its another end with the terminal 5 of the secondary winding T2.

3. A current driven toroid-free feedback type ballast according to claim 1, wherein the filter and rectifier circuit is a full bridge rectifier circuit comprising a bridge rectifier, a filter including an inductor and a resistor, both are configured as a shunt connection and an electrolyte capacitor C1 connected across terminals 1 and 3 of the bridge rectifier; one end of the filter is coupled with commercial AC power supply via a fuse while another end with terminal 4 of the bridge rectifier.

4. A current driven toroid-free feedback type ballast according to claim 1, wherein the filter and rectifier circuit is indicated as a voltage multiplying rectifier circuit.

5. A current driven toroid-free feedback type ballast according to claim 1, wherein it further comprises a power factor correction circuit, input end of which is coupled with the output end of the filter and rectifier circuit and its output end with the input end of the switch and resonant circuit.

6. A current driven toroid-free feedback type ballast according to claim 5, wherein the power factor correction circuit comprises a MOSFET VT1, a booster inductor L, a booster diode VD, an output capacitor C0 and an APFC controller integrated circuit; wherein one end of the booster inductor L is coupled to terminal 3 of bridge rectifier and another end to the collector of the transistor Q1 through the booster diode VD; cathode of the booster diode VD is coupled with terminal 1 of the bridge rectifier via the output capacitor C0 and the anode of the booster diode VD with the terminal 1 of the bridge rectifier via the MOSFET VT1, while gate of the MOSFET VT1 is coupled to the APFC controller.

7. A current driven toroid-free feedback type ballast according to claim 1, wherein the lamp load comprises a lamp tube and capacitors C4, C5; wherein at both ends of the lamp tube two connection points a, b and a′, b′ are respectively provided, both ends of capacitor C5 in shunt connection with the lamp tube are connected respectively with connection point b, b′, and another connection point a′ of the lamp tube is coupled with the terminal 2 of the three winding transformer, while another connection point a of the lamp tube is coupled with the collector of the transistor Q1 via the capacitor C4.

8. A current driven toroid-free feedback type ballast according to claim 7, wherein the capacitor C5 in shunt connection with the lamp tube is further in shunt connection with a PTC preheating device.

9. A current driven toroid-free feedback type ballast according to claim 1, wherein a turn ratio between the primary winding and the secondary winding of the three winding transformer ranges from 30:1 to 400:1.

10. A current driven toroid-free feedback type ballast according to claim 1, wherein resistance values of the resistors R5 and R6 are equal.

11. A current driven toroid-free feedback type ballast according to claim 2, wherein it further comprises a power factor correction circuit, input end of which is coupled with the output end of the filter and rectifier circuit and its output end with the input end of the switch and resonant circuit.

12. A current driven toroid-free feedback type ballast according to claim 11, wherein the power factor correction circuit comprises a MOSFET VT1, a booster inductor L, a booster diode VD, an output capacitor C0 and an APFC controller integrated circuit; wherein one end of the booster inductor L is coupled to terminal 3 of bridge rectifier and another end to the collector of the transistor Q1 through the booster diode VD; cathode of the booster diode VD is coupled with terminal 1 of the bridge rectifier via the output capacitor C0 and the anode of the booster diode VD with the terminal 1 of the bridge rectifier via the MOSFET VT1, while gate of the MOSFET VT1 is coupled to the APFC controller.
